(19) United States
(12) Patent Application Publication
(10) Pub. No.: US 2020/0184827 A1
(43) Pub. Date: Jun. 11, 2020

(54) ELECTRONIC CONTROL DEVICE AND VEHICLE COMPRISING THE SAME

(71) Applicant: LG Electronics Inc., Seoul (KR)

(72) Inventors: Suho PARK, Seoul (KR); Hansung KIM, Seoul (KR); Jaeseung BAE, Seoul (KR); Jaehwan YOON, Seoul (KR); Hyunho KI, Seoul (KR); Changhun SUNG, Seoul (KR)

(21) Appl. No.: 16/711,054

(22) Filed: Dec. 11, 2019

(30) Foreign Application Priority Data
Dec. 11, 2018 (KR) PCT/KR2018/015683

(51) Int. Cl. G08G 1/00; H04L 29/08; G08G 1/095; G08G 1/09; G08G 1/01

(52) U.S. Cl. CPC G08G 1/22; H04L 67/12; G08G 1/0116; G08G 1/093; G08G 1/095

(57) ABSTRACT

A vehicle control device and a vehicle comprising the same are disclosed, which may control the vehicle and at least one of vehicle electronic units provided in the vehicle. The vehicle control device comprises a communication unit for performing communication with the other vehicles located within a predetermined range, and a processor for performing communication with the other vehicles through the communication unit to make sure of platooning, wherein the processor may configure a platoon with one or more of the other vehicles based on a traffic signal located at the front of the vehicle if the vehicle stops at the intersection.

### CROSS-REFERENCE TO RELATED APPLICATIONS

Pursuant to 35 U.S.C. § 119(a), this application claims the benefit of earlier filing date and right of priority to International Application No. PCT/KR2018/015683, filed on Dec. 11, 2018, the contents of which is incorporated by reference herein in its entirety.

### BACKGROUND OF THE INVENTION

### 1. Field of the Invention

The present invention relates to a vehicle control device and a vehicle comprising the same, which may control the vehicle and at least one of vehicle electronic units provided in the vehicle.

### 2. Background of the Invention

A vehicle refers to means of transporting people or goods by using kinetic energy. Representative examples of vehicles include automobiles and motorcycles.

For safety and convenience of a user who uses the vehicle, various sensors and devices are provided in the vehicle, and functions of the vehicle are diversified.

The functions of the vehicle may be divided into a convenience function for promoting driver's convenience, and a safety function for enhancing safety of the driver and/or pedestrians.

First, the convenience function has a development motive associated with the driver's convenience, such as providing infotainment (information+entertainment) to the vehicle, supporting a partially autonomous driving function, or helping the driver ensuring a field of vision at night or at a blind spot. For example, the convenience functions may include various functions, such as an active cruise control (ACC), a smart parking assist system (SPAS), a night vision (NV), a head up display (HUD), an around view monitor (AVM), an adaptive headlight system (AHS), and the like.

The safety function is a technique of ensuring safeties of the driver and/or pedestrians, and may include various functions, such as a lane departure warning system (LDWS), a lane keeping assist system (LKAS), an autonomous emergency braking (AEB), and the like.

Moreover, the vehicle has a platooning function for driving a plurality of vehicles in one platoon (or group) by maintaining the vehicles to be close to one another through a vehicle interval control. The plurality of vehicles may exchange movement of vehicles within a group and potential abnormal status information through communication with the other vehicles, and may maintain a vehicle interval through a control according to the exchange.

If platooning is performed, fuel of the vehicles included in the platoon may be saved, and the interval between the vehicles is narrow, whereby a road possession rate of the vehicles is lowered to relieve a traffic congestion.

Platooning may be performed through vehicle-to-everything (V2X) communication and vehicle-to-vehicle (V2V) communication. A platoon of platooning includes a leader vehicle located at a front line of the platoon and follow vehicles which follow the leader vehicle. One or more follow vehicles move along the leader vehicle by receiving driving information of the leader vehicle.

Generally, the platoon is made by a platoon request of the follow vehicles and a platoon grant of the leader vehicle. Since the leader vehicles shares its vehicle driving information, which may be regarded as personal information, with the follow vehicles, the grant is required. The request and the grant are generated by being triggered by user inputs of passengers who have got on the corresponding vehicles.

Although platooning has many advantages, it has not been popularized in that a request and a grant are required between passengers who have got on the leader vehicle and the follow vehicles.

### SUMMARY OF THE INVENTION

Therefore, an object of the present invention is to solve the aforementioned problem and the other problems due to limitations and disadvantages of the related art.

Another object of the present invention is to provide a vehicle control device and a vehicle comprising the same, which can perform platooning by automatically forming a platoon even without a request and/or a grant of passengers.

Other object of the present invention is to provide a vehicle control device and a vehicle comprising the same, in which vehicles predicted to move in the same direction may automatically form a platoon when waiting for a signal at the intersection.

The present invention relates to a vehicle control device, a vehicle comprising the same, and a vehicle control method of a vehicle control system comprising a plurality of vehicles.

To achieve these and other advantages and in accordance with the purpose of the invention, as embodied and broadly described herein, the vehicle control device comprises a communication unit for performing communication with the other vehicles located within a predetermined range; and a processor for performing communication with the other vehicles through the communication unit to make sure of platooning, wherein the processor may configure a platoon with one or more of the other vehicles based on a traffic signal located at the front of the vehicle if the vehicle stops at the intersection.

According to one embodiment, the processor may calculate the number of vehicles based on the traffic signal, and may configure the platoon such that the other vehicles equivalent to the number of vehicles are included in the platoon.

According to one embodiment, the processor may extract a time allocated to a driving direction of the vehicle from the traffic signal, and may calculate vehicles, which can pass through the intersection within the time, as the number of vehicles.

According to one embodiment, the processor may configure the platoon such that one or more of the vehicles predicted to move to the driving direction of the vehicle, among the other vehicles which stop at the same lane as that of the vehicle, are included in the platoon.

According to one embodiment, the number of vehicles may be varied depending on one or more of the vehicles predicted to move to the driving direction of the vehicle.

According to one embodiment, the processor may select platoon vehicles in accordance with a preset reference, and may configure the platoon, in which the platoon vehicles are included, in response to a platoon grant message received from the selected platoon vehicles.

According to one embodiment, the processor may determine a deadline based on the traffic signal, and may share the deadline with the other vehicles located within the predetermined range.

According to one embodiment, the processor may include a first vehicle in the platoon if a grant message is received from the first vehicle prior the deadline, and may not include a second vehicle in the platoon if a grant message is received from the second vehicle after the deadline.

According to one embodiment, the deadline may be determined based on a switching timing of the traffic signal from a first signal to a second signal.

According to one embodiment, the processor may transmit a platoon request message to the selected platoon vehicles only.

According to one embodiment, the processor may search for a position of each of the other vehicles based on the vehicle, and may select one or more of the other vehicles based on the position of each of the other vehicles.

According to one embodiment, if the vehicle is able to perform platooning with an nth vehicle and an n+2th vehicle but is not able to perform platooning with an n+1th vehicle in a state that m vehicles are sequentially located at the rear of the same lane as that of the vehicle, the processor may configure the platoon from the first vehicle to the nth vehicle, and m and n to may be natural numbers.

According to one embodiment, at least one other vehicle predicted to move to a driving direction of the vehicle, among the other vehicles which stop at the same lane as that of the vehicle, may be selected as one or more of the other vehicles.

According to one embodiment, the processor may share vehicle driving information for the platooning with one or more of the other vehicles configured as the platoon.

According to one embodiment, the processor may stop sharing the vehicle driving information with one or more of the other vehicles in response to passing of the last vehicle among the vehicles included in the platoon through the intersection.

According to one embodiment, the processor may configure the platoon if a position of the vehicle at the intersection satisfies a reference condition, and may not configure the platoon if the position does not satisfy the reference condition.

According to one embodiment, the processor may determine whether to satisfy the reference condition based on a front image of the vehicle, which is taken.

According to one embodiment, the processor may determine whether to move the vehicle in response to switching of the traffic signal to allow movement of the vehicle, and may release the platoon if movement of the vehicle is impossible.

The present invention may be applied to a vehicle comprising the vehicle control device described as above and/or a vehicle control method.

Moreover, the present invention provides a vehicle control method of a vehicle control system comprising m vehicles located within a predetermined range.

The vehicle control method comprises outputting, from a first vehicle, which satisfies a reference condition, among the m vehicles, a platoon request message for configuring a platoon with one or more other vehicles based on a traffic signal located at the front of the first vehicle; transmitting a platoon response message from a second vehicle to the first vehicle in response to the platoon request message; determining whether the first vehicle configures the platoon with the second vehicle based on the traffic signal if the platoon response message is received from the second vehicle; and performing platooning by the first and second vehicles in response to switching of the traffic signal from a first signal to a second signal if the platoon is configured.

According to one embodiment, the vehicle control method may further comprise allowing the first vehicle to determine whether to satisfy the reference condition based on its front image which is taken.

Advantageous effect of the vehicle control device, the vehicle comprising the same, and the vehicle control method of the vehicle control system comprising the plurality of vehicles according to the present invention are as follows.

Since the plurality of vehicles automatically form and release a platoon at a certain status, a fuel saving effect occurs. Since vehicles predicted to move in the same direction automatically form a platoon when waiting for a signal at the intersection, more vehicles may pass through the intersection with respect to the same signal.

Since the platoon is formed in a limited status that vehicles stop, it is possible to make sure of safety.

### BRIEF DESCRIPTION OF THE DRAWING

FIG. 1 is a block diagram illustrating a vehicle control device according to the present invention.

FIG. 2 is a flow chart illustrating an operation of the vehicle control device of FIG. 1.

FIGS. 3A, 3B and 3C are exemplary views illustrating the embodiment of FIG. 2.

FIG. 4 is a flow chart illustrating a method for calculating the number of vehicles for configuring a platoon based on a traffic signal.

FIG. 5 is an exemplary view illustrating the embodiment of FIG. 4.

FIG. 6 is a flow chart illustrating communication between a leader vehicle and follow vehicles.

FIG. 7 is a flow chart illustrating an operation of a vehicle control device provided in a leader vehicle.

FIG. 8 is a flow chart illustrating a method for determining a deadline for configuring a platoon based on a traffic signal.

FIG. 9 is a flow chart illustrating a condition for configuring a platoon.

FIG. 10 is a block diagram illustrating a vehicle control device for controlling a plurality of vehicles.

FIG. 11 is a flow chart illustrating a method for controlling a plurality of vehicles by the vehicle control device of FIG. 10.

### DETAILED DESCRIPTION OF THE PREFERRED EMBODIMENT

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to an embodiment of the present invention may be understood as a conception including cars, motorcycles and the like. Hereinafter, the vehicle will be described based on a car.

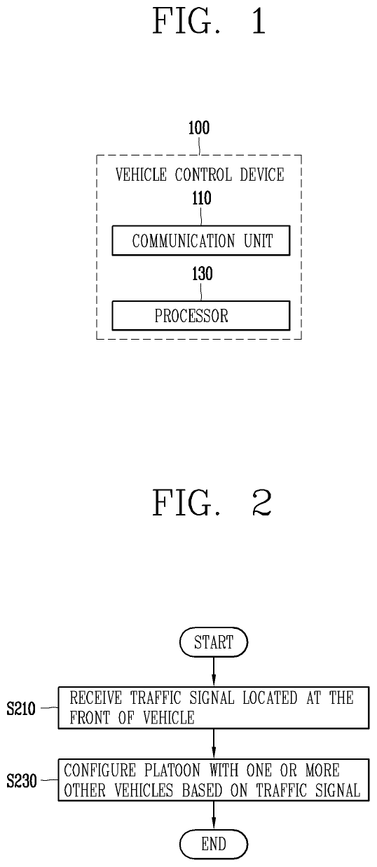

FIG. 1 is a block view illustrating a vehicle control device according to an embodiment of the present invention.

The vehicle control device refers to a device for controlling the vehicle.

For example, the vehicle control device may be a device mounted on a vehicle to perform communication through CAN communication and generate messages for controlling the vehicle and/or electric devices mounted on the vehicle.

As another example, the vehicle control device may be located outside the vehicle, like a server or a communication device, and may perform communication with the vehicle through a mobile communication network. In this case, the vehicle control device can remotely control the vehicle and/or the electric devices mounted on the vehicle using the mobile communication network.

The vehicle control device 100 is provided in the vehicle, and may be implemented as an independent device detachable from the vehicle or may be integrally installed on the vehicle to construct a part of the vehicle 100.

Referring to FIG. 1, the vehicle control device 100 includes a communication unit 110 and a processor 130.

The communication unit 110 is configured to perform communications with various components provided in the vehicle. For example, the communication unit 110 may receive various information provided through a controller area network (CAN). In another example, the communication unit 110 may perform communication with all devices capable of performing communication, such as a vehicle, a mobile terminal, a server, and another vehicle. This may be referred to as Vehicle to everything (V2X) communication. The V2X communication may be defined as a technology of exchanging or sharing information, such as traffic condition and the like, while communicating with a road infrastructure and other vehicles during driving.

The communication unit 110 may receive information related to driving of the vehicle from most of electric devices in the vehicle 100. The information transmitted from the electric device provided in the vehicle to the vehicle control device 100 is referred to as ‘vehicle driving information (or vehicle travel information)’.

Vehicle driving information includes vehicle information and surrounding information related to the vehicle. Information related to an inside of the vehicle with respect to a frame of the vehicle 100 may be defined as the vehicle information, and information related to an outside of the vehicle may be defined as the surrounding information.

The vehicle information refers to information related to the vehicle itself. For example, the vehicle information may include a driving speed, a driving direction, an acceleration, an angular velocity, a location (GPS), a weight, a number of passengers in the vehicle, a braking force of the vehicle, a maximum braking force, air pressure of each wheel, a centrifugal force applied to the vehicle, a driving mode of the vehicle (autonomous driving mode or manual driving mode), a parking mode of the vehicle (autonomous parting mode, automatic parking mode, manual parking mode), whether or not a user is present in the vehicle, and information associated with the user.

The surrounding information refers to information related to another object located within a predetermined range around the vehicle, and information related to the outside of the vehicle. The surrounding information of the vehicle may be a state of a road surface on which the vehicle is traveling (e.g., a frictional force), the weather, a distance from a front-side (rear-side) vehicle, a relative speed of a front-side (rear-side) vehicle, a curvature of a curve when a driving lane is the curve, information associated with an object existing in a reference region (predetermined region) based on the vehicle, whether or not an object enters (or leaves) the predetermined region, whether or not the user exists near the vehicle, information associated with the user (for example, whether or not the user is an authenticated user), and the like.

The surrounding information may include ambient brightness, temperature, a position of the sun, information related to nearby subject (a person, another vehicle, a sign, etc.), a type of a driving road surface, a landmark, line information, and driving lane information, and information required for an autonomous driving/autonomous parking/automatic parking/manual parking mode.

In addition, the surrounding information may further include a distance from an object existing around the vehicle to the vehicle, collision possibility, a type of an object, a parking space for the vehicle, an object for identifying the parking space (for example, a parking line, a string, another vehicle, a wall, etc.), and the like.

The vehicle driving information is not limited to the example described above and may include all information generated from the components provided in the vehicle.

Meanwhile, the processor 130 is configured to control one or more electric devices provided in the vehicle using the communication unit 110.

Specifically, the processor 130 may determine whether or not at least one of a plurality of preset conditions is satisfied, based on vehicle driving information received through the communication unit 110. According to a satisfied condition, the processor 130 may control the one or more electric devices in different ways.

In connection with the preset conditions, the processor 130 may detect an occurrence of an event in an electric device provided in the vehicle and/or application, and determine whether the detected event meets a preset condition. At this time, the processor 130 may detect the occurrence of the event from information received through the communication unit 110.

The application is a concept including a widget, a home launcher, and the like, and refers to all types of programs that can be run on the vehicle. Accordingly, the application may be a program that performs a function of a web browser, a video playback, a message transmission/reception, a schedule management, or an application update.

Further, the application may include a forward collision warning (FCW), a blind spot detection (BSD), a lane departure warning (LDW), a pedestrian detection (PD) A Curve Speed Warning (CSW), and a turn-by-turn navigation (TBT).

For example, the event occurrence may be a missed call, presence of an application to be updated, a message arrival, start on, start off, autonomous driving on/off, pressing of an LCD awake key, an alarm, an incoming call, a missed notification, and the like.

As another example, the occurrence of the event may be a generation of an alert set in the advanced driver assistance system (ADAS), or an execution of a function set in the ADAS. For example, the occurrence of the event may be a occurrence of forward collision warning, an occurrence of a blind spot detection, an occurrence of lane departure warning, an occurrence of lane keeping assist warning, or an execution of autonomous emergency braking.

As another example, the occurrence of the event may also be a change from a forward gear to a reverse gear, an occurrence of an acceleration greater than a predetermined value, an occurrence of a deceleration greater than a predetermined value, a change of a power device from an internal combustion engine to a motor, or a change from the motor to the internal combustion engine.

In addition, even when various electronic control units (ECUs) provided in the vehicle perform specific functions, it may be determined as the occurrence of the event.

For example, when a generated event satisfies the preset condition, the processor 130 may control the communication unit 110 to display information corresponding to the satisfied condition on one or more displays provided in the vehicle.

Meanwhile, the vehicle control device 100 may execute a function related platooning for forming a platoon by a plurality of vehicles. For example, as a leader vehicle of the platoon, the vehicle control device 100 may transmit its vehicle driving information to follow vehicles included in the platoon. For another example, as the follow vehicle of the platoon, the vehicle control device 100 may perform platooning based on the vehicle driving information received from the leader vehicle. The vehicle control device provided in the follow vehicle may transmit a control message to one or more vehicle electronic units provided in the follow vehicle based on the vehicle driving information of the leader vehicle.

The communication unit 110 of the vehicle control device 100 is configured to perform communication with the other vehicles located within a predetermined range. For example, the predetermined range may be a possible communication distance for performing platooning.

The processor 130 performs communication with the other vehicles through the communication unit to form platooning. The processor 130 may share its vehicle driving information with the other vehicles or use vehicle driving information of the other vehicles, which is received from the other vehicles, for platooning.

Hereinafter, an operation of the vehicle control device 100 will be described in more detail with reference to the accompanying drawings.

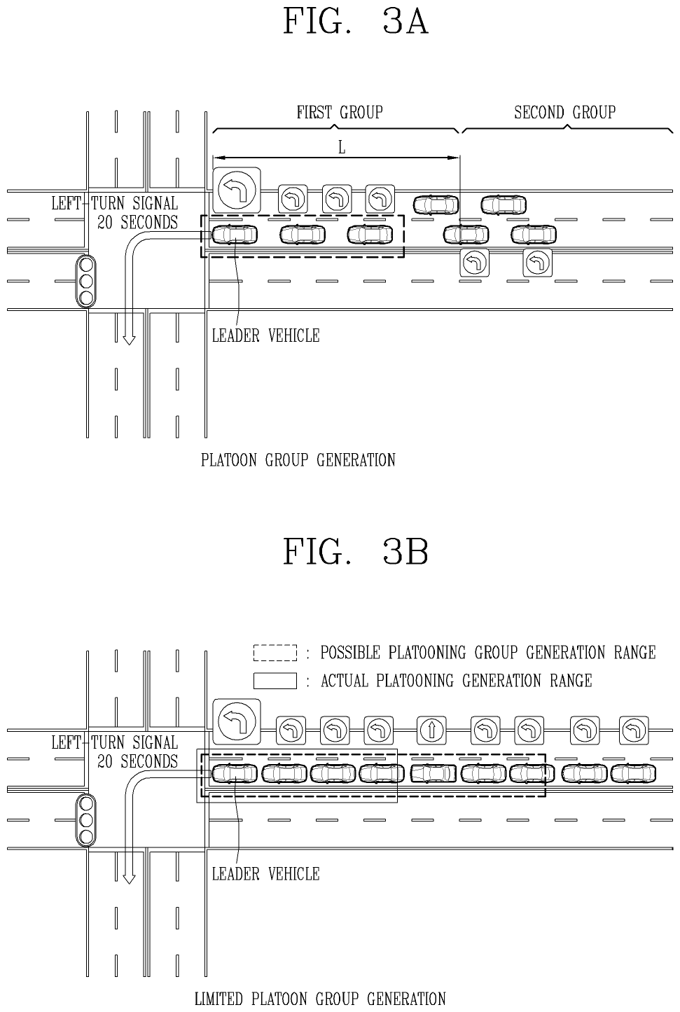

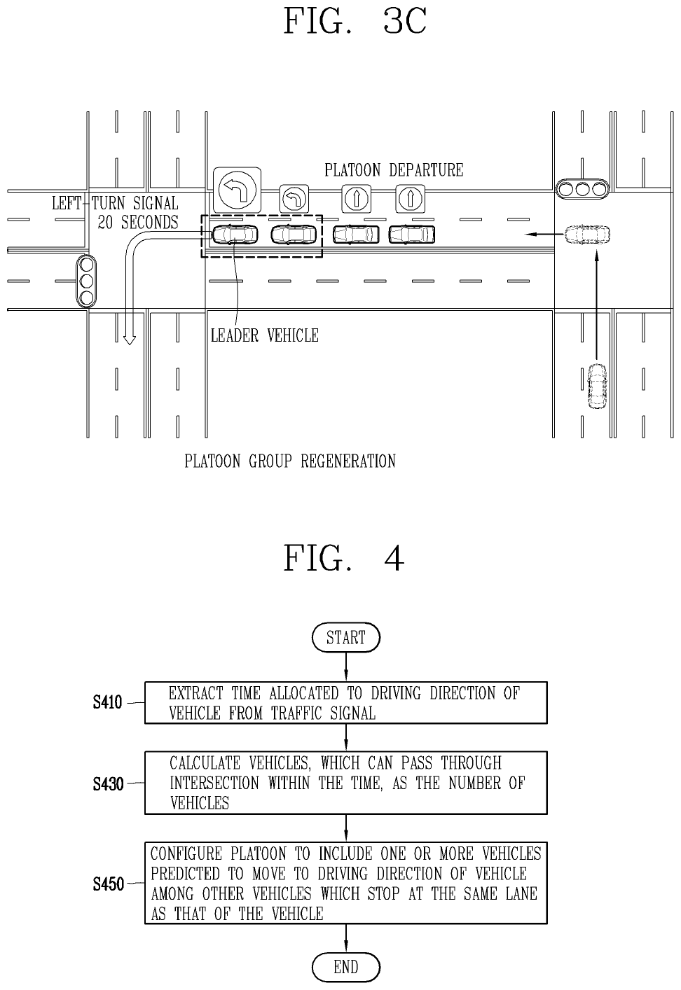

FIG. 2 is a flow chart illustrating an operation of the vehicle control device of FIG. 1, and FIGS. 3A, 3B and 3C are exemplary views illustrating the embodiment of FIG. 2.

The processor 130 receives a traffic signal of a traffic light located at the front of the vehicles (S210).

The processor 130 may receive a traffic signal from a traffic light, etc. located at the front of the vehicles through the communication unit 100.

If a plurality of traffic signals are received, the processor 130 may select at least one traffic signal, which should be obeyed by the vehicles in consideration of a lane where the vehicles stop and a path to a destination.

The traffic signal may include a switching timing of a first signal to a second signal, a remaining time after switching from the first signal to the second signal, a time allocated to the second signal, etc.

The processor 130 configures a platoon with one or more vehicles based on the traffic signal (S230).

The processor 130 may configure platoon with the other vehicles which can together pass through the traffic signal based on the traffic signal.

For example, as shown in FIG. 3A, if the vehicle should turn to the left by receiving a left-turn signal at the intersection, the processor 130 may extract the time allocated to the left-turn signal. If the time allocated to the left-turn signal corresponds to 20 seconds, the processor may search for the other vehicles, which can turn to the left within 20 seconds through platooning, and may configure a platoon with the searched vehicles.

If there are a plurality of vehicles based on a random vehicle, the vehicles may be categorized into a first group which can be configured as a platoon, and a second group which cannot be configured as a platoon. The processor 130 may categorize the first and second groups based on the traffic signal, and may configure a platoon by performing communication with the other vehicles included in the first group.

The processor 130 may extract sizes, lengths and shapes of the other vehicles by analyzing other vehicle information received from the other vehicles. The processor 130 may calculate a length L of the platoon. The processor 130 may determine the length L of the platoon, which can pass through the traffic signal at a time, based on the traffic signal, and may determine whether the other vehicle corresponds to the first group or the second group in consideration of its vehicle length and a length of the other vehicle.

The length L of the platoon is varied depending on the traffic signal. For example, if the time allocated to the traffic signal is a first time, and the length of the platoon may be determined as a first length, and if the time allocated to the traffic signal is a second time longer than the first time, the length of the platoon may be determined as a second length longer than the first length.

The processor 130 may select at least one other vehicle predicted to move to a driving direction of the vehicle, among the other vehicles which stop at the same lane as that of the vehicle, as one or more of the other vehicles.

The procedure of configuring the platoon may be performed when the vehicle stops at the intersection. Since the time for performing communication with the other vehicle is required to configure the platoon, resources of the vehicle may be wasted, whereby there may be a risk resulting in an accident. Therefore, the processor 130 may determine whether the vehicle stops at the intersection, based on the vehicle driving information received through the communication unit 110, and may configure a platoon for passing through the intersection when the vehicle stops at the intersection.

If the platoon is configured, platooning is performed.

The processor 130 may transmit its vehicle driving information for platooning to one or more of the other vehicles configured as the platoon. The vehicle driving information may restrictively be transmitted to the other vehicles included in the platoon, and encoding may be performed for the vehicle driving information. In other words, transmission of the vehicle driving information is limited to or blocked for the other vehicles which are not included in the platoon.

The platoon may automatically be configured between vehicles having the same moving path at the intersection environment and the moving path between the vehicles configured in the platoon is changed, whereby platooning may be performed to reach a point departing from the platoon. Alternatively, platooning may be performed until the last vehicle included in the platoon completely passes through the intersection, and platooning may be released if the last vehicle passes through the intersection.

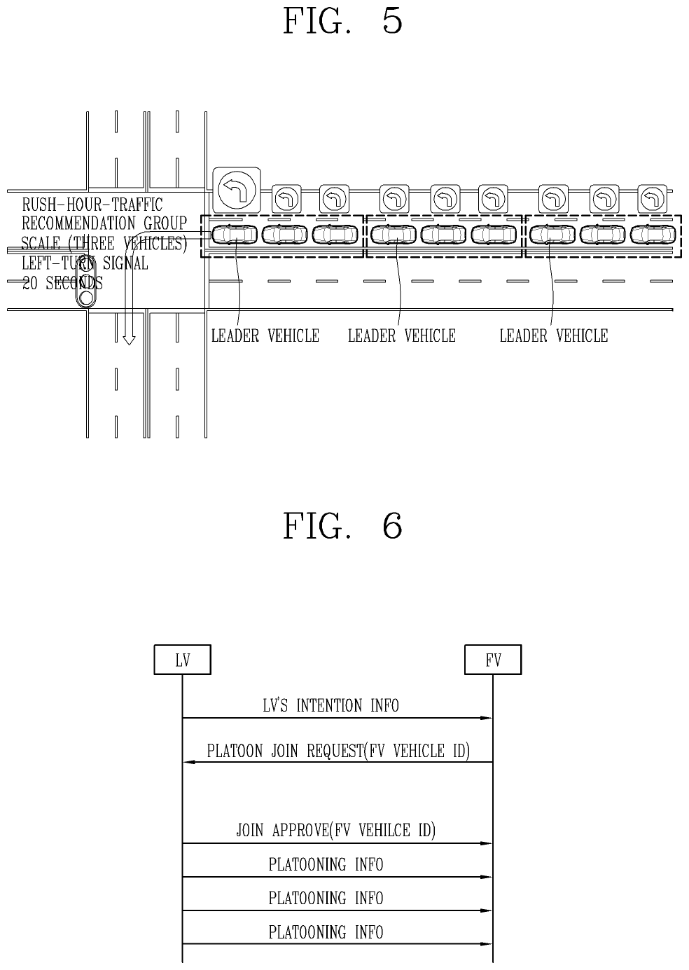

FIG. 4 is a flow chart illustrating a method for calculating the number of vehicles for configuring a platoon based on a traffic signal, and FIG. 5 is an exemplary view illustrating the embodiment of FIG. 4.

The processor 130 extracts the time allocated to the driving direction of the vehicle from the traffic signal (S410).

Next, the processor 130 may calculate the number of vehicles, which can pass through the intersection within the above time, as the number of vehicles for configuring the platoon (S430).

The processor 130 may calculate the number of vehicles for configuring the platoon, based on the traffic signal, and may configure the platoon such that the other vehicles equivalent to the number of vehicles for configuring the platoon may be included in the platoon.

The processor 130 may extract the time allocated to the driving direction of the vehicle from the traffic signal, and may calculate the number of vehicles, which can pass through the intersection within the above time, as the number of vehicles for configuring the platoon. That is, the platoon is configured to be equivalent to the vehicles which can pass through the traffic signal to be obeyed by the vehicles at the intersection at a time.

The processor 130 may configure the platoon such that one or more of the vehicles predicted to move to the driving direction of the vehicle, among the other vehicles which stop at the same lane as that of the vehicle, may be included in the platoon (S450).

Platooning means that the follow vehicles drive while following the leader vehicle and maintain a narrow distance from the vehicle ahead. Generally, although a driver should make sure of a safety distance from the vehicle ahead in accordance with a speed of the vehicle, since driving of the vehicle ahead may be predicted in case of platooning, it is not required to make sure of a safety distance. Since a size and a length of the platoon should uniformly be maintained, the processor 130 configures the platoon with one or more of the vehicles predicted to move to the driving direction of the vehicle among the other vehicles which stop at the same line as that of the vehicle.

The number of vehicles is varied depending on one or more of the vehicles predicted to move to the driving direction of the vehicle. For example, if a bus having a long vehicle length corresponds to the other vehicle, the number of vehicles is one. However, if a small car having a short vehicle length corresponds to the other vehicle, the number of vehicles may be two or three. The number of vehicles may be varied depending on vehicles which stop at the same lane.

FIG. 6 is a flow chart illustrating communication between a leader vehicle and follow vehicles.

The leader vehicle may broadcast intention information for guiding that it has been ready to configure a platoon. The intention information may include information for configuring a communication link.

The follow vehicles may transmit a platoon request message for joining the platoon to the leader vehicle. The platoon request message may include information on the follow vehicles, for example, a predicted moving path of the follow vehicles, sizes, lengths and shapes of the follow vehicles, and acceleration/deceleration capabilities of the follow vehicles.

The leader vehicle may determine whether the follow vehicles correspond to the first group which can join the platoon or the second group which cannot join the platoon, in response to the platoon request message received from the follow vehicles.

If the follow vehicles correspond to the first group, the leader vehicle may transmit a platoon grant message to the follow vehicles and transmit vehicle driving information for group driving.

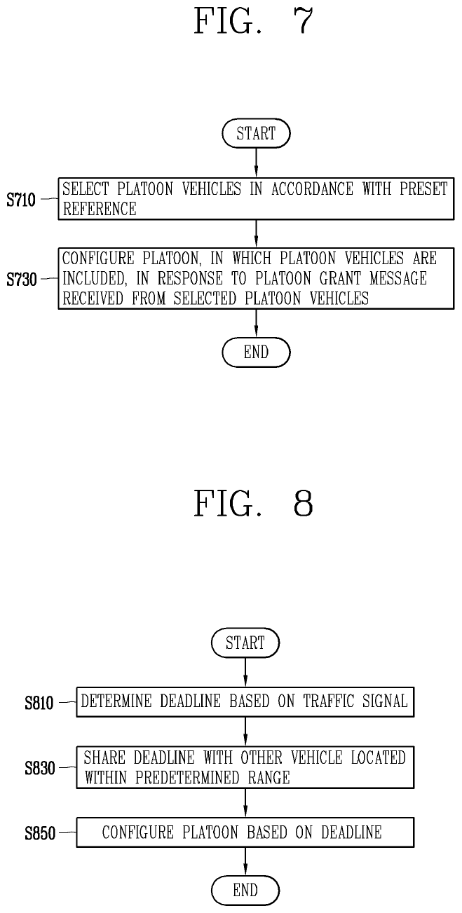

FIG. 7 is a flow chart illustrating an operation of a vehicle control device provided in a leader vehicle.

The processor 130 may select platoon vehicles in accordance with a preset reference (S710).

The processor may search for a position of each of the other vehicles based on the vehicle and select one or more of the other vehicles based on the position of each of the other vehicles.

If the vehicle is able to perform platooning with an nth vehicle and an n+2th vehicle but is not able to perform platooning with an n+1th vehicle in a state that m vehicles are sequentially located at the rear of the same lane as that of the vehicle, the processor may configure the platoon from the first vehicle to the nth vehicle. In this case, m and n are natural numbers.

The processor transmits the platoon request message to the selected platoon vehicles only. This is to prevent resources from being wasted due to unnecessary transmission of the platoon request message to the vehicles which cannot join the platoon.

Next, the processor may configure the platoon, in which the platoon vehicles are included, in response to the platoon grant message received from the selected platoon vehicles (S730). The processor may select the platoon vehicles in accordance with the preset reference and configure the platoon in which the platoon vehicles are included, in response to the platoon grant message received from the selected platoon vehicles.

FIG. 8 is a flow chart illustrating a method for determining a deadline for configuring a platoon based on a traffic signal.

The processor 130 may determine a deadline based on the traffic signal (S810).

If the platoon is formed after the vehicles already start, it is impossible for the vehicles to pass through the traffic signal at a time, whereby the last vehicle of the platoon may violate the traffic signal. Therefore, the processor 130 may determine the deadline for configuring the platoon.

The deadline may be determined based on a switching timing of the traffic signal from the first signal to the second signal. That is, the deadline may be varied depending on the traffic signal.

The deadline may be shared by the other vehicles located within a predetermined range (S830). The processor 130 may determine the deadline based on the traffic signal and share the deadline with the other vehicles located within the predetermined range.

The processor 130 may configure the platoon based on the deadline (850).

If a grant message is received from the first vehicle prior the deadline, the processor 130 may include the first vehicle in the platoon, and if the grant message is received from a second vehicle after the deadline, the processor 130 may not include the second vehicle in the platoon.

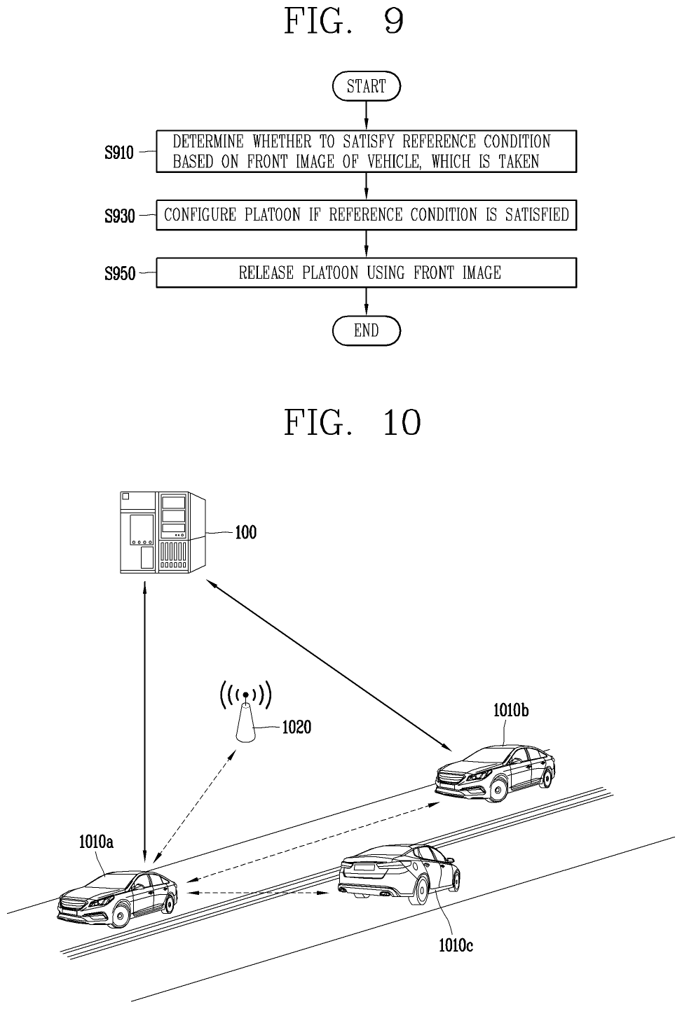

FIG. 9 is a flow chart illustrating a condition for configuring a platoon.

The processor determines whether to satisfy a reference condition based on a front image of the vehicle, which is taken (S910).

The processor may determine that the reference condition is satisfied if the vehicle is located at the front of the intersection. That is, the processor configures a platoon if the vehicle can start simultaneously with switching of the traffic signal from a first signal to a second signal. This is because that the vehicle cannot start due to the other vehicle in spite of signal switching if the vehicle is not located at the front of the intersection and thus the other vehicle is located in front of the vehicle.

The processor configures the platoon if the reference condition is satisfied (S930). The processor does not configure the platoon if the reference condition is not satisfied. That is, the processor performs a function of configuring the platoon as the leader vehicle if the vehicle is located at the front of the intersection. If the reference condition is not satisfied, execution of the function of configuring the platoon is limited.

Meanwhile, the present invention may be applied to the vehicle comprising the vehicle control device 100 described with reference to FIGS. 8 and 9.

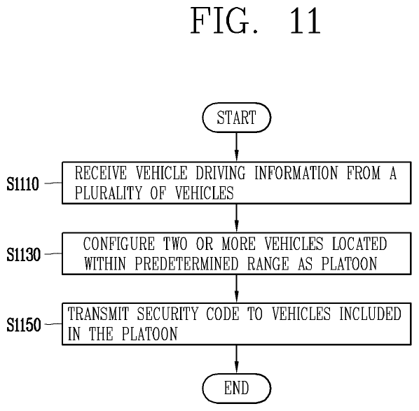

FIG. 10 is a block diagram illustrating a vehicle control device for controlling a plurality of vehicles, and FIG. 11 is a flow chart illustrating a method for controlling a plurality of vehicles by the vehicle control device of FIG. 10.

The vehicle control device 100 may be built in the vehicle to control the vehicle, and may remotely control the vehicle by using a wireless network in a state that it is not built in the vehicle.

The communication unit 110 may be configured to perform CAN communication if the vehicle control device 100 is built in the vehicle, and may be configured to perform wireless communication through a wireless network 1020 if the vehicle control device 100 is not built in to the vehicle. In other words, the communication unit may be configured to perform different types of communications depending on types of the vehicle control device.

The vehicle control device 100 may correspond to a server, a base station or an infrastructure of V2I, perform communication with one or more vehicles 1010a to 1010c and generate a control message for controlling each vehicle.

For example, the vehicle control device 100 may receive first vehicle driving information, which is generated from the first vehicle 1010a, from the first vehicle 1010a and generate a control message for controlling the first vehicle 1010a based on the first vehicle driving information.

The control message may be associated with various control functions such as a function of configuring a destination of the first vehicle 1010a, a function of changing a driving mode, a function of controlling a brake or an engine/motor to change a speed, and a function of controlling a steering device to change a driving direction.

Referring to FIG. 11, the processor 130 receives vehicle driving information from the plurality of vehicles (S1110).

The vehicle driving information may include information generated within the vehicle or transmitted from an external device not the vehicle to the vehicle as described in FIG. 1. For example, the traffic signal located at the front of the first vehicle 1010a may be received by the first vehicle 1010a, and may be transmitted to the vehicle control device 100 as first vehicle driving information of the first vehicle 1010a.

Next, two or more vehicles located within a predetermined range may be configured as a platoon (S1130).

The processor 130 may specify a predetermined range based on the vehicle driving information received from the plurality of vehicles, and may configure two or more of the vehicles located within the predetermined range as one platoon.

For example, the processor 130 may select one traffic signal and specify a road, to which the selected traffic signal is applied, within a predetermined range. The processor 130 may configure vehicles, which can together pass through the traffic signal, as one platoon based on the traffic signal.

For example, if a left-turn signal at the intersection is selected as the traffic signal, the processor 130 may specify a predetermined range based on the left-turn signal, search for the vehicles located within the predetermined range and then configure the vehicles, which satisfy the reference condition, as one platoon.

The processor 130 may categorize the vehicles located within the predetermined range into a first group which can be configured as a platoon and a second group which cannot be configured as a platoon. The processor 130 may categorize the first and second groups based on the traffic signal and configure the platoon by performing communication with the other vehicles included in the first group.

The processor 130 may extract a size, a length and a shape of each vehicle by analyzing the vehicle driving information received from each vehicle. The processor 130 may calculate a length L of the platoon. The processor 130 may determine the length L of the platoon, which can pass through the traffic signal at a time, based on the traffic signal, and may determine whether the other vehicles correspond to the first group or the second group in consideration of its vehicle length and lengths of the other vehicles.

The length L of the platoon is varied depending on the traffic signal. For example, if the time allocated to the traffic signal is a first time, the length may be determined as a first length, and if the time allocated to the traffic signal is a second time longer than the first time, the length may be determined as a second length longer than the first length.

Next, the processor may transmit a security code to the vehicles included in the platoon (S1150).

A security code which enables mutual authentication of the vehicles may be transmitted to the vehicles included in the platoon such that the vehicles included in the platoon may receive V2X. The vehicles included in the platoon may perform mutual authentication by using the security code, and may share their vehicle driving information with the other vehicles through V2X.

The vehicle control device 100 which controls one or more vehicles through a wireless network may perform the operations described with reference to FIGS. 8 and 9.

The present invention can be implemented as computer-readable codes (applications or software) in a program-recorded medium. The method of controlling the autonomous vehicle can be realized by a code stored in a memory or the like.

The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the processor or the controller. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

What is claimed is:

1. A vehicle control device for controlling a vehicle, the vehicle control device comprising:
a communication unit configured to communicate with other vehicles located within a predetermined range from the vehicle; and
a processor configured to control the communication unit to communicate with the other vehicles for platooning, wherein the platooning comprises:
receiving, by the processor, a plurality of traffic signals from at least one traffic light located at an intersection; and
setting, based on one or more of the received plurality of traffic signals, a platoon that includes the vehicle and one or more other vehicles.

2. The vehicle control device of claim 1, wherein the processor is further configured to extract a time of a traffic signal that matches a driving direction of the vehicle at the intersection.

3. The vehicle control device of claim 2, wherein the processor is further configured to calculate, based on the extracted time of the traffic signal, a number of vehicles that drive through the intersection within the extracted time.

4. The vehicle control device of claim 3, wherein the processor is further configured to set, based on the calculated number of vehicles, one or more platoons that include the number of vehicles, and
wherein the one or more platoons drive through the intersection within the extracted time and along the driving direction of the traffic signal.

5. The vehicle control device of claim 4, wherein the number of vehicles in each of the one or more platoons varies based on characteristics of vehicles in the one or more platoons.

6. The vehicle control device of claim 1, wherein the processor is further configured to:
broadcast, from the vehicle, intention information to the other vehicles for setting a platoon;
receive, from the other vehicles and based on the broadcasted intention information, platoon request messages for joining the platoon with the vehicle;
select, based on a determination that the received platoon request messages satisfy a preset reference, platoon vehicles from the other vehicles;
exchange platoon grant messages with the selected platoon vehicles; and
set, based on the exchanged platoon grant messages, the platoon that includes the vehicle and the selected platoon vehicles.

7. The vehicle control device of claim 6, wherein the processor is further configured to:
determine, based on a switching timing of the traffic signals, a deadline for setting the platoon; and
share the determined deadline with the other vehicles located within the predetermined range from the vehicle.

8. The vehicle control device of claim 7, wherein the platoon includes a first platoon vehicle based on a determination that a grant message of the first platoon vehicle is received prior to the deadline, and
wherein the platoon does not include a second platoon vehicle based on a determination that a grant message of the second platoon vehicle is received after the deadline.

9. The vehicle control device of claim 8, wherein the deadline is determined based on a switching timing of the traffic signals from a first signal to a second signal.

10. The vehicle control device of claim 6, wherein the processor is further configured to control the communication device to transmit platoon grant messages to the selected platoon vehicles only.

11. The vehicle control device of claim 1, wherein the processor is further configured to search for relative positions of each of the other vehicles to the vehicle; and select platoon vehicles from the other vehicles based on the relative positions of each of the other vehicles to the vehicle.

12. The vehicle control device of claim 11, wherein, based on a determination that a platoon is configured to include an nth vehicle and an n+2th vehicle but not an n+1th vehicle in a state that m vehicles are sequentially located behind the vehicle and on the same lane of the vehicle, the processor is configured to set the platoon from a first vehicle to the nth vehicle, and wherein m and n are all natural numbers.

13. The vehicle control device of claim 11, wherein the processor is further configured to select at least one of the other vehicles that is located on a different lane to the vehicle and that drives along a driving direction of the vehicle, as one of the platoon vehicles.

14. The vehicle control device of claim 1, wherein the processor is further configured to share driving information of the vehicle with one or more other vehicles included in the platoon.

15. The vehicle control device of claim 14, wherein the processor is further configured to stop sharing the driving information of the vehicle with one or more other vehicles included in the platoon based on a determination that a last vehicle in the platoon has passed through the intersection.

16. The vehicle control device of claim 1, wherein the processor is further configured to set the platoon based on a determination that a position of the vehicle at the intersection satisfies a reference condition, and
wherein the processor is further configured to reject the platoon based on a determination that the position of the vehicle does not satisfy the reference condition.

17. The vehicle control device of claim 16, wherein the processor is further configured to determine whether the position of the vehicle at the intersection satisfies the reference condition based on an image taken in front of the vehicle.

18. The vehicle control device of claim 1, wherein the processor is further configured to release the vehicle for driving through the intersection in response to a switching to a pass traffic signal, and cancel the platoon in response to a switching to a stop traffic signal.

19. A vehicle control method for controlling m vehicles located within a predetermined range, the vehicle control method comprising:
broadcasting, from a first vehicle among the m vehicles, based on a traffic signal located in front of the first vehicle and a determination that the first vehicle satisfies a reference condition, intention information for setting a platoon to one or more remaining vehicles among the m vehicles;
receiving, from the one or more remaining vehicles and based on the broadcasted intention information, platoon request messages to the first vehicle;
selecting, based on a determination that the traffic signal matches a driving direction of a second vehicle from the one or more remaining vehicles and the platoon request message is received from the second vehicle, the second vehicle for platooning; and
performing, based on a switching of the traffic signals from a first signal to a second signal, platooning to include the first vehicle and the second vehicle in the platoon.

20. The vehicle control method of claim 19, further comprising determining, by the first vehicle and based on an image taken in front of the first vehicle, whether a position of the first vehicle at an intersection satisfies the reference condition.
